(19) United States
(12) Patent Application Publication
(10) Pub. No.: US 2010/0083634 A1
(43) Pub. Date: Apr. 8, 2010

(54) SOLID FUEL ROCKET, SOLID ROCKET FUEL AND METHOD

(76) Inventor: David Lloyd Summers, Chicago, IL (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/247,656

(22) Filed: Oct. 8, 2008

(51) Int. Cl. F02K 9/10

(52) U.S. Cl. 60/253; 60/39.464

(57) ABSTRACT

A rocket engine for manned or unmanned space flight and atmospheric flight uses an elongated fuel structure that is external to the combustion chamber and that is fed into the combustion chamber during operation of the rocket. The elongated fuel structure includes propellant elements and may include coolant elements and gas generating elements as well. The elongated fuel structure of one embodiment is a ribbon. The ribbon is fed between two opposed wheels of the fuel pump, which seal the engine from escaping gases while permitting the elongated fuel structure to be drawn into the engine. The opposed wheels may serve to activate the gas generating elements, so that gas pressure generated thereby drives the propellant elements into the combustion chamber of the rocket engine. The activation of the gas generating elements also provides coolant to the engine from the coolant elements, in one embodiment.

### BACKGROUND OF THE INVENTION

1. Field of the Invention

The present invention relates generally to an apparatus and method for fueling a rocket with a solid propellant and to a rocket engine fueled by a solid propellant as well as to a rocket fuel structure.

2. Description of the Related Art

Rocket engines fueled by a solid propellant, so-called solid fuel rockets, commonly have a fuel housing within which is one or more bodies of combustible solid that is ignited to drive hot gasses from a rearwardly directed nozzle. Once the combustible solid fuel is ignited, it generally must burn completely without the possibility of shut down or control. Regulation of the burn rate is accomplished by providing different fuel formulas at different locations within the housing. In flight regulation is not possible.

Rockets are currently extremely expensive to operate, limiting their applications to specialized fields such as space and orbital work. A much larger market can be realized if a rocket's operational cost can be lowered. For example a small aircraft capable of flying people from Chicago to Beijing in 45 minutes would appeal to a large market if available at reasonable costs.

Rocket's costs are primarily related to complexity and size. The smaller a rocket, the less it costs to develop and fly. This is due largely to a decrease in complexity, but also due to a decrease in the “worst case” disaster severity the safety requirements for a 747 are much larger than those of a Cessna two-seater.

As complexity increases cost increases exponentially, as each part needs to be designed, tested, and maintained. In addition, each part is interrelated to all the other parts. If the heat shielding is too massive, you need more propellant, which cascades to larger engines, bigger wings, etc. leading to a still larger heat shield. So in addition to a lower parts count, the parts should be less interrelated to achieve lower costs.

Solid rockets are by far the simplest forms of rockets. They do not require finely tuned injectors, propellant mixing, pumping, storage and movement in tanks, hard starts, etc. Historically, solid rockets have been held back by their lower performance—primarily due to the entire propellant supply being necessarily contained inside the engine itself. Solid rockets typically also have lower Isp (specific impulse—a measure of engine propellant efficiency) than liquid propellants, and therefore require higher mass fractions to achieve the same total impulse.

Making a rocket that can achieve a large change in velocity is very difficult. The basic governing equation is v=Isp·9.8·ln(MR); where v is the change in velocity, Isp is a measure of the rocket engine's thrust performance, and MR is the mass ratio (full stage mass divided by the empty stage mass). Rockets typically have an Isp between 300 and 450 seconds, and a mass ratio of about 10. Unfortunately, higher Isp engines tend to have lower mass ratios—so achieving a stage velocity change of 9,000 m/s or more has been difficult to achieve. Maximum Isp is limited primarily by available energy in the fuel, and so is difficult to increase. A solid fuel feeder increases stage velocity by allowing extremely high mass ratio stages, instead of focusing on Isp.

Essentially, stage mass ratio is governed by two things: the engine's thrust to weight ratio, and the tank mass fraction. Rocket engines inherently have large thrust ratios—but tank mass fraction is difficult to make acceptable. First the tanks must typically hold cryogenic fuels, which limits the materials that can be used while building them. Second the highest Isp fuels have low density, and so require larger tanks volumes for a given mass. Third, most rocket engines require high inlet pressures, so the tanks must hold high pressures.

Making these tanks lightweight virtually requires low design margins. This makes them very fragile—if they are taken just a little off optimum, they rupture. When they rupture, the high internal pressure forces the fuel out of the tank and into the surrounding area. Typically, this force (and the rocket engine burning below it!) ignites the propellant and destroys the rocket and anything nearby.

As an example of the problem mass ratio poses during launch vehicle design, consider: The rocket's performance can be defined as:

delta−v=Isp·ln(1+Mₚᵣₒₚₑₗₗₐₙₜ/[M_{engine}+Mₜₐₙₖₛ+M_{heatshield}+M_{structure}+M_{fixed}+M_{payload}Mₚᵣₒₚₑₗₗₐₙₜ])

Where:

M_{engine}=ThrustToWeightRatio·[M_{engine}+Mₜₐₙₖₛ+M_{heatshield}+M_{structure}+M_{fixed}+M_{payload}+Mₚᵣₒₚₑₗₗₐₙₜ])

Mₜₐₙₖₛ=F(Isp,Mₚᵣₒₚₑₗₗₐₙₜ)

M_{heatshield}=F(Tank Size)

Because all these variables are interdependent, a solution is extremely hard to find. As the design misses its mass targets, an increase must be made in the propellant load—which requires increased engine mass (which requires yet more fuel), and increased tank mass (which requires larger and heavier heat shields, and heavier structure). These interdependencies make large delta-v vehicle designs very risky—small subsystem performance prediction errors cause large vehicle performance misses.

It is possible to avoid all of these problems by using a solid propellant injected into a rocket engine. First, no tank is required—a solid fuel can be its own tank. This means that the mass ratio can be practically as high as the engine thrust ratio. Solid fuels are not typically cryogenic, so they require no special handling or materials. Because the solid fuel is not pressurized at all, there is no equivalent to a tank rupture. The fuel can (and should) be designed to not burn well at atmospheric pressure—so a worst case crash or failure means a slowly burning rope-like mass slumps to the ground. Refueling is also faster than with liquid fuels—instead of transferring fuels between containers, the fuel end is simply threaded into the engine.

Further, the interdependencies in vehicle design are broken. Adding propellant only requires a larger engine. Since there is no tank, the heat shield design can remain unchanged. If the propellant is self supporting (or is hanging in the rear of the vehicle), no additional structure is needed for the extra propellant loads. This makes vehicle design far easier, and makes the minimum vehicle scale far smaller as well.

### SUMMARY OF THE INVENTION

The present invention provides solid rocket fuel configuration as an elongated fuel structure having a plurality of solid fuel bodies that are provided sequentially to a combustion chamber of a solid fuel rocket. In one embodiment, the elongated fuel structure includes a plurality of coolant chambers disposed along the elongated body which contain coolant for use during operation of the rocket engine. In a preferred embodiment, the elongated structure also includes gas generators associated with the coolant chambers for expelling the coolant and for generating gas to drive the in feed of the fuel to the combustion chamber. The elongated fuel structure provides particular benefit when configured as a ribbon containing alternating propellant elements and coolant/gas generator elements.

Another aspect of the present invention provides a feed apparatus for feeding an elongated fuel structure containing solid rocket fuel into a combustion chamber of a rocket. In one embodiment, the feed apparatus includes two opposed wheels turning in opposite directions and between which is fed the elongated fuel body. The preferred wheels have shaped surfaces to accommodate the solid fuel bodies disposed at spaced intervals along the elongated structure. Embodiments that utilize an elongated fuel containing structure including coolant chambers also have shaped surfaces to accommodate the coolant chambers provided in the elongated structure.

As a further aspect, the elongated fuel structure includes gas generators that are activated to force the fuel into the combustion chamber of the rocket engine. In particular, the gas generators are activated in series as they are brought into a high pressure area of the rocket engine. The gas generators generate a high pressure gas within a high pressure chamber, which applies pressure to drive the fuel structures into the combustion chamber of the rocket. Fueling is thereby carried out as a result of operation of the gas generators. The wheels seal the high pressure chamber to prevent or at least reduce escape of the high pressure gas, while permitting the elongated fuel structure to be drawn into the rocket engine.

Yet a further aspect of the present invention is a solid fuel rocket having a combustion chamber in the body of the rocket and an elongated structure extending from the body of the rocket, the elongated structure containing fuel for the rocket that is fed into the combustion chamber as needed. During travel, the elongated structure trails behind the rocket and is drawn in to the rocket as the fuel is consumed. Possible embodiments include an arrangement of solid rocket fuel bodies disposed along the elongated structure and an arrangement of coolant chambers likewise disposed along the elongated structure. A further aspect provides that the coolant chambers are associated with gas generators that generate a gas to expel the coolant from the coolant chambers, the gas also assisting in feeding the fuel bodies into the combustion chamber.

In yet a further aspect of the invention, a rocket engine is provided having a centrally disposed combustion chamber and a pair of nozzle supports extending laterally from the combustion chamber, the nozzle supports including rearwardly directed nozzles. The nozzles exhaust the hot gases and material from the combustion chamber to provide thrust for the rocket. The nozzles are preferably directable to permit steering, or vectoring, of the rocket. In one embodiment, the nozzle supports include two or more different nozzle shapes and/or sizes that are selectively positionable to receive the exhaust gases from the combustion chamber, the different nozzles providing different degrees of thrust or other performance differences when each respective nozzle is positioned for operation.

In a further improvement, the elongated fuel structure also contains coolant that is released from the elongated fuel structure during use so that the coolant can be provided to portions of the rocket engine to prevent overheating. The coolant of one embodiment is contained within chambers disposed in the elongated fuel structure between propellant bodies and is released from the chambers when the corresponding coolant chambers are drawn into the rocket engine, in particular into a coolant collecting area of the rocket engine. The coolant collecting area of one embodiment is a gravity or thrust assisted collecting area for liquid coolant that has been expelled into the rocket engine from the coolant cylinder. The coolant is provided to coolant channels around the combustion chamber, nozzles, or other engine areas as needed.

### BRIEF DESCRIPTION OF THE DRAWINGS

FIG. 1 is a side perspective view of an elongated fuel structure, or ribbon, having solid fuel bodies and coolant/gas generator cylinders in alternating spaced arrangement along its length;

FIG. 2 is a top perspective view of a solid propellant body and coolant cylinder portion of the ribbon of FIG. 1;

FIG. 3 is a top plan view of the ribbon with the solid fuel elements and gas generator elements and a battery;

FIG. 4 is a side cross sectional view of a propellant pump portion of the rocket engine for intake of the elongated fuel structure of FIG. 1;

FIG. 5 is a side cross sectional view of the propellant pump portion of FIG. 4 from a direction perpendicular to the view of FIG. 4;

FIG. 6 is an enlarged partial perspective view of a nozzle mounting portion of the rocket engine according to the principles of the present invention;

FIG. 7 is a side view of the present rocket engine including a combustion chamber, propellant pump and nozzle mounting;

FIG. 8 is a side cross sectional view of the present rocket engine showing a combustion chamber and propellant pump;

FIG. 9 is a side view of the rocket engine with the combustion chamber, thrust nozzles, and propellant pump, and an elongated fuel structure being fed into the propellant pump;

FIG. 10 is an enlarged cross sectional view of the propellant pump showing the pump wheels engaging a coolant chamber of the elongated fuel structure; and

FIG. 11 is an enlarged cross sectional view of the propellant pump of FIG. 10 showing the pump wheels engaging a solid propellant body.

FIG. 12 is a side view of an aircraft using the present rocket engine.

### DETAILED DESCRIPTION OF THE PREFERRED EMBODIMENTS

In FIG. 1 is shown an elongated fuel structure 20 for fueling a rocket engine. The elongated fuel structure includes a ribbon formed of a ribbon housing 22, for example, of nylon, a series of spherical propellant elements 24 mounted along the ribbon housing 22 and a series of coolant and gas generator elements 26 mounted along the ribbon housing 22 between the propellant elements 24.

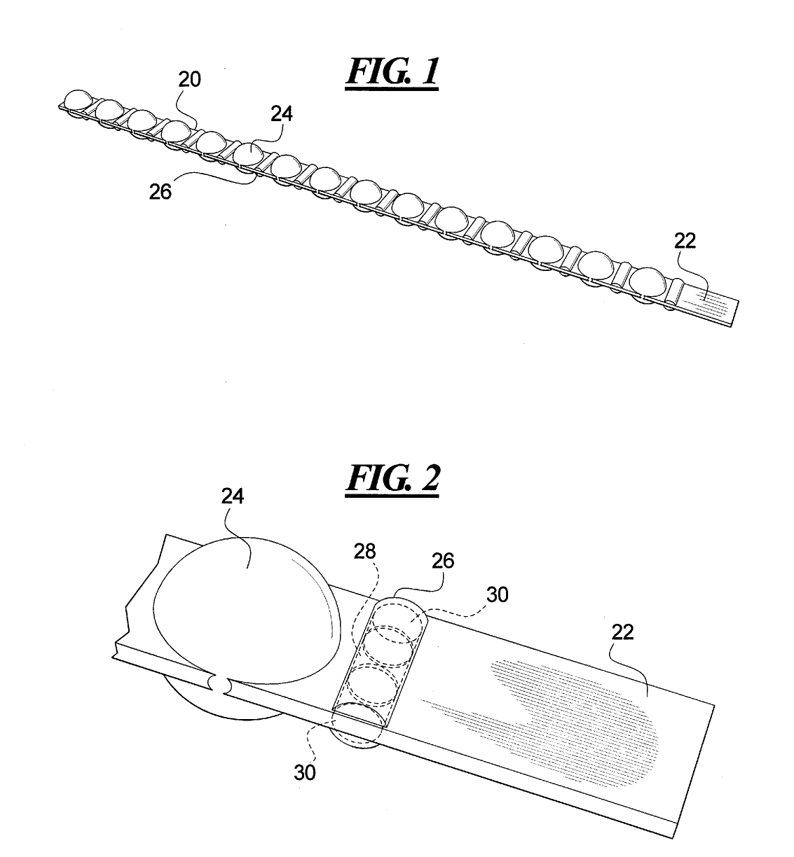

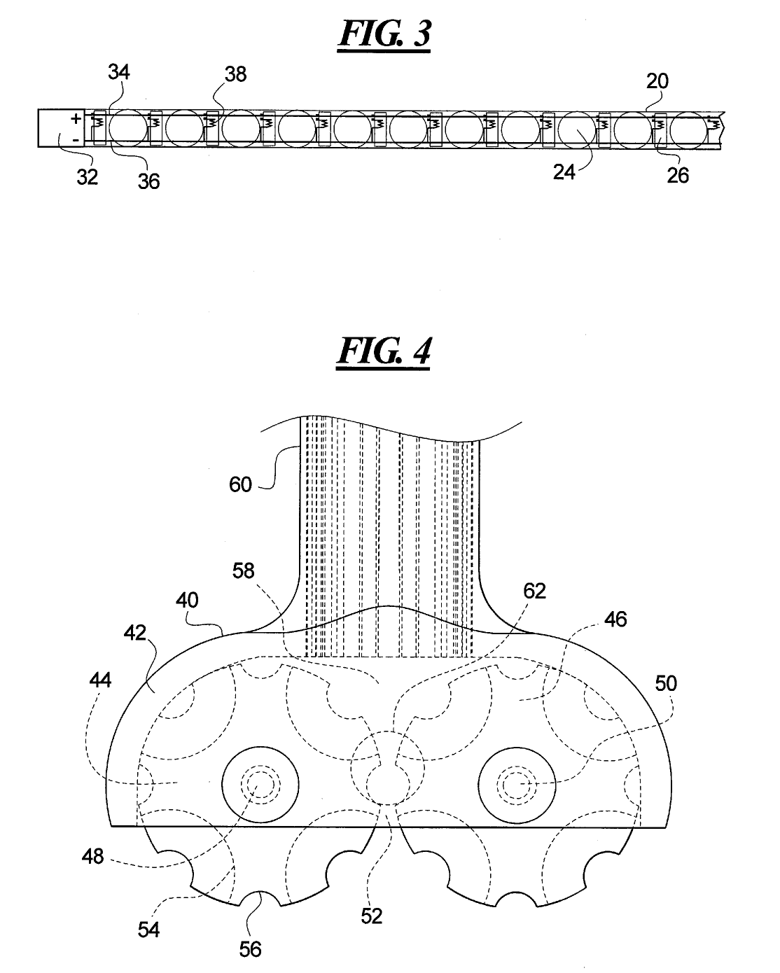

In FIG. 2, a portion of the ribbon housing 22 is a flattened body. In a preferred embodiment, a nylon fabric strip has the propellant elements 24 affixed thereto, such as by an adhesive. The propellant elements 24 are formed into hemispheres and two such hemispheres are affixed to the nylon strip on opposite sides to form a spherical propellant element. A covering or coating, such as a plastic or rubber paint or coating, is applied over the propellant elements 24 as possibly over the fabric strip as well. The covering or coating encases and seals the propellant material and aids in forming a seal with the shaped recesses in the pump wheels, as will be described later. An alternative embodiment provides that the ribbon is formed of two elongated strips of ribbon material, such as a woven or non-woven fabric, that are joined to one another to hold the propellant elements 24 and coolant and gas generator elements 26 in the elongated fuel structure 20. The strips of ribbon material encase or at least partially encase the elements 24 and 26. Other means of holding the elements 24 and 26 in the ribbon 22 are also possible and are within the scope of the present invention.

The propellant element 24 is a sphere of a solid rocket fuel that has a diameter substantially equal to or slightly wider than the width of the ribbon 22. The sphere 24 is held in the ribbon 22 by being encased or partially encased within the material of the ribbon 22. It is also foreseeable that the propellant element 24 may be of some other shape and may be held in the elongated fuel structure by some other means. For example, the propellant element 24 may be of a cylindrical shaped having an axis generally extended along the length of the ribbon, or may be of a capsule shape having generally hemispherical ends and a cylindrical mid portion. Any shape that passes between the rollers of the pump and through the pump exit tube or throat into the combustion chamber while maintaining a seal condition is possible.

The coolant and gas generator element 26 is a cylindrical body having a gas generator 28 between two coolant chambers 30. Activation of the gas generator 28 causes gas to be generated that is expelled into the rocket engine. As will be shown, the gas generator expels the gas into a high pressure area of the rocket engine. The expelling gas also forces the coolant out of the coolant chambers 30 into rocket engine, in particular, into the high pressure area, where the coolant is collected and used for cooling portions of the rocket engine during operation.

FIG. 3 shows that the elongated fuel structure 20 with the arrangement of coolant and gas generator elements 26 and propellant elements 24 along its length. A power source 32, such as a battery, is provided as part of or is connected to the elongated fuel structure 20. Conductors in the form of wires 34 and 36 run the length of the elongated fuel structure 20. At or near each gas generator element 26 is provided a switch 38. The switch 38 is operable to supply power from the power source 32 to the respective gas generator elements 26. By supplying power to the gas generator 26, the switch activates the gas generator to cause the gas and the coolant to be ejected.

The elongated fuel structure may have many other configurations and constructions as will be apparent to those of skill in the art. A possible alternative embodiment provides the propellant in the elongated fuel structure, but provides some or all of the gas for the high pressure area of the pump from a source within the rocket engine or craft. This high pressure gas feeds the propellant into the combustion chamber. The gas source may be a pressurized gas container or a gas generator, generating gas from combustion of a fuel or other combustible.

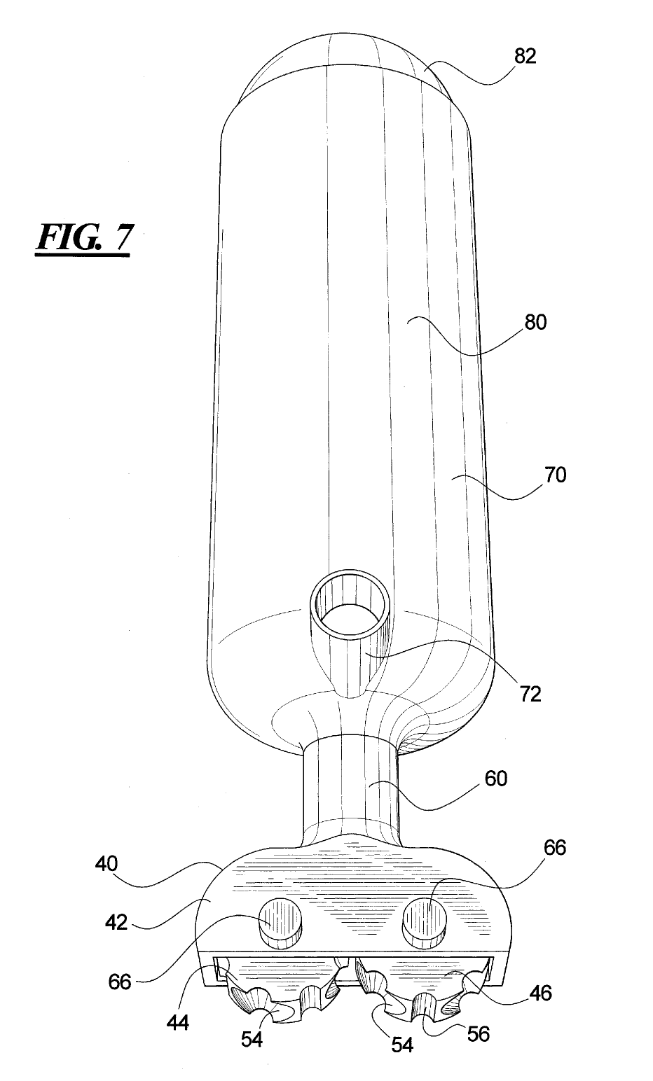

With reference to FIG. 4, a pump 40 is provided for receiving the elongated fuel structure and feeding the fuel into a combustion chamber (see FIG. 7). The pump 40 includes a housing 42 within which is mounted two pump wheels 44 and 46. The wheels 44 and 46 rotate on parallel axles 48 and 50 with their outer perimeters forming a nip 52 between which is fed the elongated fuel structure 20 of FIG. 1. The outer perimeters of the wheels 44 and 46 are provided with cut outs 54 and 56 that are shaped to accept the propellant elements 24 and coolant and gas generator elements 26, respectively, as the wheels 44 and 46 rotate on the axles 48 and 50. Preferably, a seal is provided by the wheels 44 and 46 bearing against the ribbon 22 and the propellant elements 24 and coolant and gas generator elements 26.

A high pressure area 58 is formed within the pump 40. The high pressure area 58 is sealed by the wheels 44 and 46 and by the housing 42 to prevent or reduce escape of gasses contained within the high pressure area 58. Seals are provided in the pump housing 42 to contain the high pressure gases. A pump exit tube or passage 60 extends from the high pressure area 58 of the pump 40 to a combustion chamber. The high pressure gases in the high pressure area 58 are ported to the combustion chamber through the pump exit tube 60.

At or near the region of close approach of the wheels 44 and 46 is provided coolant holding areas 62. The coolant holding areas 62 receive coolant, which is preferably a liquid such as water, when the coolant is ejected from the coolant cylinders 26. The coolant may be ejected into the interior space of the pump 40 and gravity or inertia moves the coolant to the coolant holding areas 62.

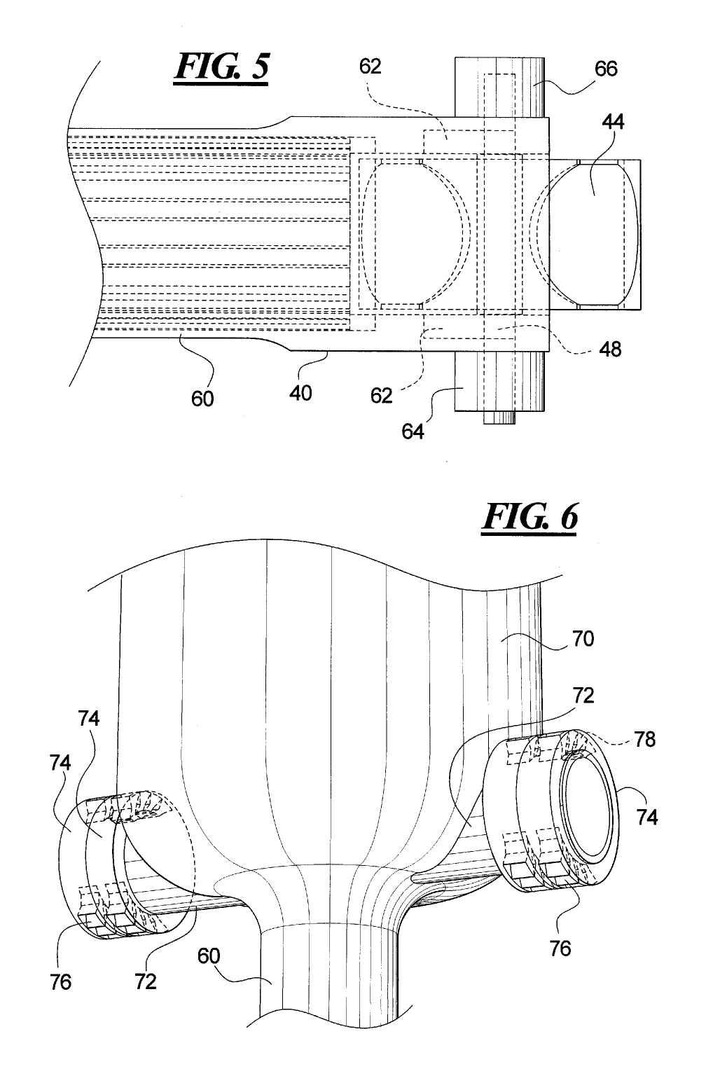

In FIG. 5, the pump 40 is shown in a view transverse to the axles 48 and 50. The shaped outer perimeter of the wheel 44 can be seen. The wheels 44 and 46 have a width approximately equal to the diameter of the propellant elements 24, which is also the approximate diameter of the interior of the pump exit tube 60. Two coolant holding areas 62 are provided, one on each side of the wheels 44 and 46. Units 64 and 66 are provided on the axles 48 and 50 of the wheels. The units 64 and 66 of one embodiment are bearing housings, or head elements, for the axles.

Referring to FIG. 6, the pump exit tube 60 is connected to a combustion chamber 70. The combustion chamber is generally cylindrical and axially aligned with the exit tube 60 and is of a greater diameter than the exit tube 60. The end of the combustion chamber 70 adjacent to the pump exit tube 60 is provided with nozzle supports 72 that extend in diametrically opposed directions from the combustion chamber 70. On the nozzle supports 72 are provided nozzle drums 74 that rotate on the supports. The supports 72 have openings that direct exhaust from the combustion chamber 70 to nozzles 76 in the drums 74. The exhaust escaping the nozzles 76 provide thrust for the rocket engine.*

In a preferred embodiment, a main combustion chamber igniter is on the propellant ribbon. The start sequence includes the steps of: a) the ribbon is threaded through the wheels, and fed into the engine until the chamber igniter is inside the main chamber, b) a larger than normal gas generator is ignited inside the high pressure area, c) the pump quickly comes up to operating pressure, d) quickly, before the propellant moves too much the propellant is ignited in the chamber. In an alternative embodiment, the combustion chamber 70 has an igniter that ignites the propellant elements 24 that are within the chamber to start the rocket. A motor or other means may be provided to initially draw the elongated fuel structure into the pump 40 during start up. Igniters are well known and would be readily applied by those of skill in this art.

The nozzles 76 are movable by rotation of the drums 74 so that steering of the rocket can be accomplished by vectoring. Two drums 74 are provided on each support 72. The drums 74 may be independently movable to provide for better steering and control. The drums 74 include a second set of nozzles 78 which provide a different expansion rate than the nozzles 76. The drums 74 can be rotated into position to receive the exhaust from the openings in the nozzle supports 72 so that the second nozzles 78 are operable. The different expansion ratios of the nozzles enables the thrust characteristics of the nozzles to be changed quickly. Further sets of nozzles may be provided for other nozzle performance characteristics as well.

Turning now to FIG. 7, the pump 40 with the wheels 44 and 46 mounted therein is shown at one end of the pump exit tube 60 while the combustion chamber 70 with the nozzle supports 72 is at the other end of the pump exit tube 60. The pump housing 42 encloses a substantial portion of the wheels 44 and 46. The combustion chamber has a cylindrical outer wall 80 and a hemispherical end 82 to enclose an interior space within which combustion of the propellant takes place.

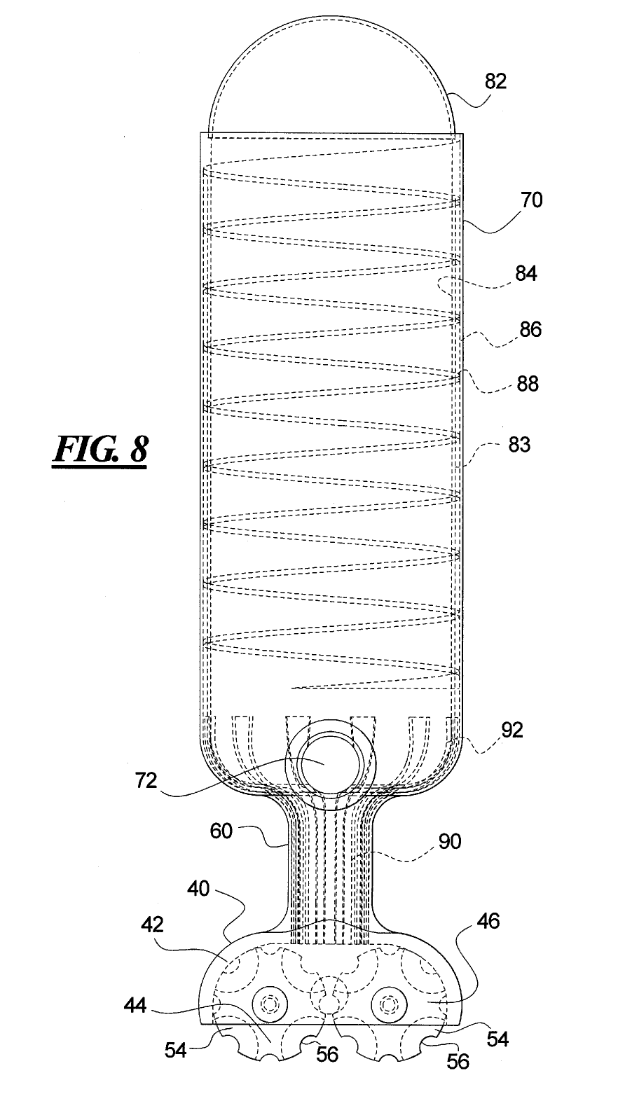

FIG. 8 illustrates interior structures of the rocket engine. The combustion chamber 70 is of a double wall construction having a helical space 83 defined between inner wall 84 and outer wall 86 by a helical divider 88. The pump exit tube 60 has channels 90 that extend longitudinally of the tube 60. The channels 90 also extend into the floor portion 92 of the combustion chamber 70. The channels 90 and helical space 83 provide space for coolant flow during operation of the rocket engine.

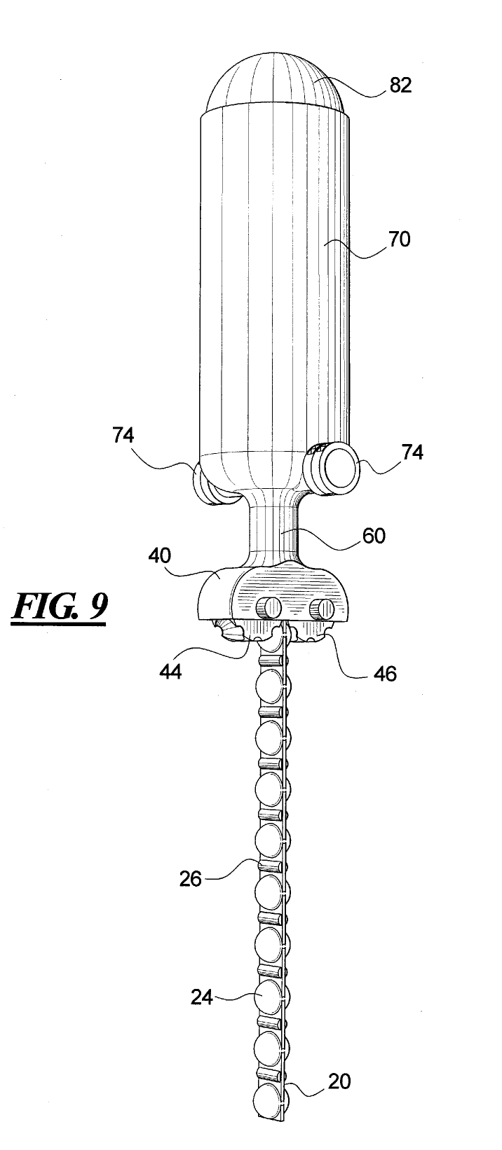

FIG. 9 shows the rocket engine with the elongated fuel structure or ribbon 20 being feed into the nip between the pump wheels 44 and 46, also referred to as injector wheels. The pump 40 feeds the propellant in the ribbon 20 through the pump exit tube 60 to the combustion chamber 70. Combusting fuel in the combustion chamber 70 produces exhaust that is directed by the nozzle drums 74 to provide thrust.

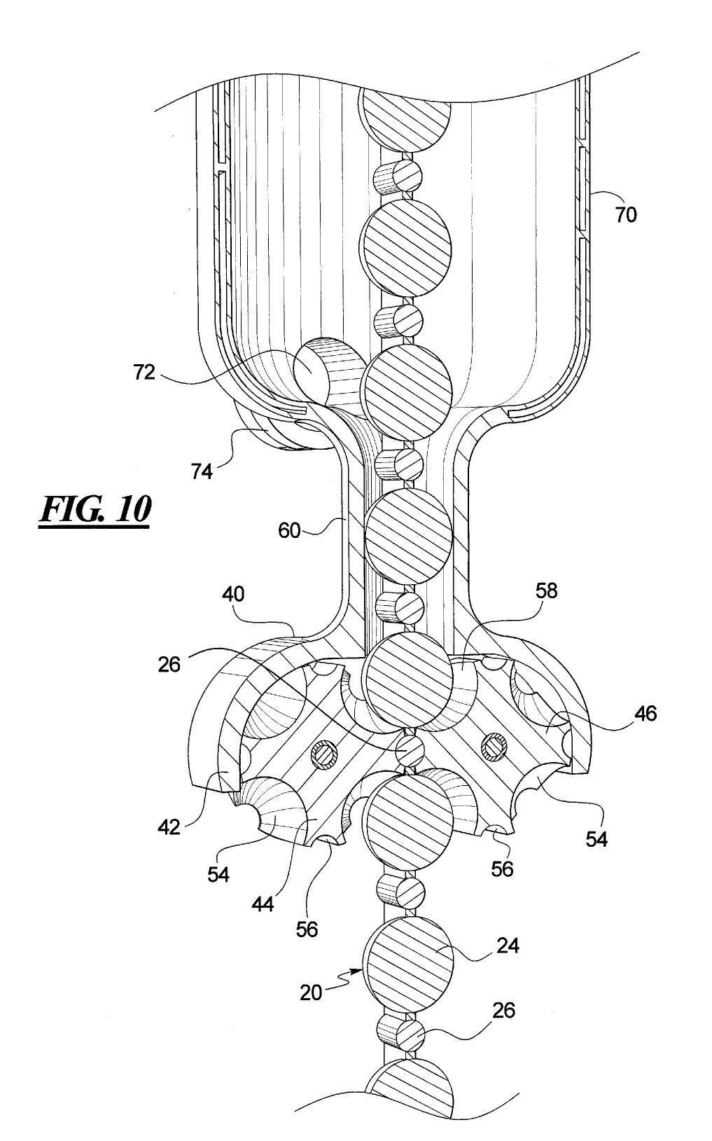

With reference to FIG. 10, the pump wheels 44 and 46 receive the elongate fuel structure 20 and the shaped recesses 56 engage the gas generator and coolant cylinder 26 that is disposed therebetween. The pressing force of the wheels 44 and 46 on the switch 38 (see FIG. 3) at or near to the gas generator and coolant cylinder 26 causes the gas generator 28 to activate, which will generate a volume of gasses that are captured in the high pressure area 61 of the pump 40. The pressure inside the high pressure area 61 increases, and acts on one or more propellant elements 24 that are within the pump exit tube 60. This causes the propellant element 24 to slide down the pump exit tube toward and into the combustion chamber 70. The ribbon structure 22 linking the propellant elements and gas generator and coolant elements 26 together draws in the elements that are external to the engine and moves the elements in series into the combustion chamber.

In order for the gases in the high pressure area 58 to push the propellant elements 24 along the pump exit tube 60, the pressure in the high pressure must be greater than that in the combustion chamber 70. The high pressure area 58 has a small volume compared to the substantially greater volume of the combustion chamber, so that a smaller volume of gasses generated by the gas generator is able to establish a high pressure within the high pressure area 58. The gasses within the high pressure area 58 are prevented from escaping by the elongated fuel structure 20 maintaining a seal between the wheels 44 and 46 and by seals in the pump 40. Except for any minor leakage, the primary escape path for the high pressure gas is through the pump exit tube as the gases push the propellant elements into the combustion chamber 70. The pressurizing gas flow is a subsonic flow, while the gases within the combustion chamber 70 exit the nozzles at supersonic speeds. The pressurizing gas of one embodiment is about one percent of the flow of the gasses leaving nozzles. The action of the high pressure pushing the propellant 24 along the tube 60 draws the ribbon through the wheels 44 and 46, causing them to turn, so that motor force is not required on the wheels during at least this stage of operation.

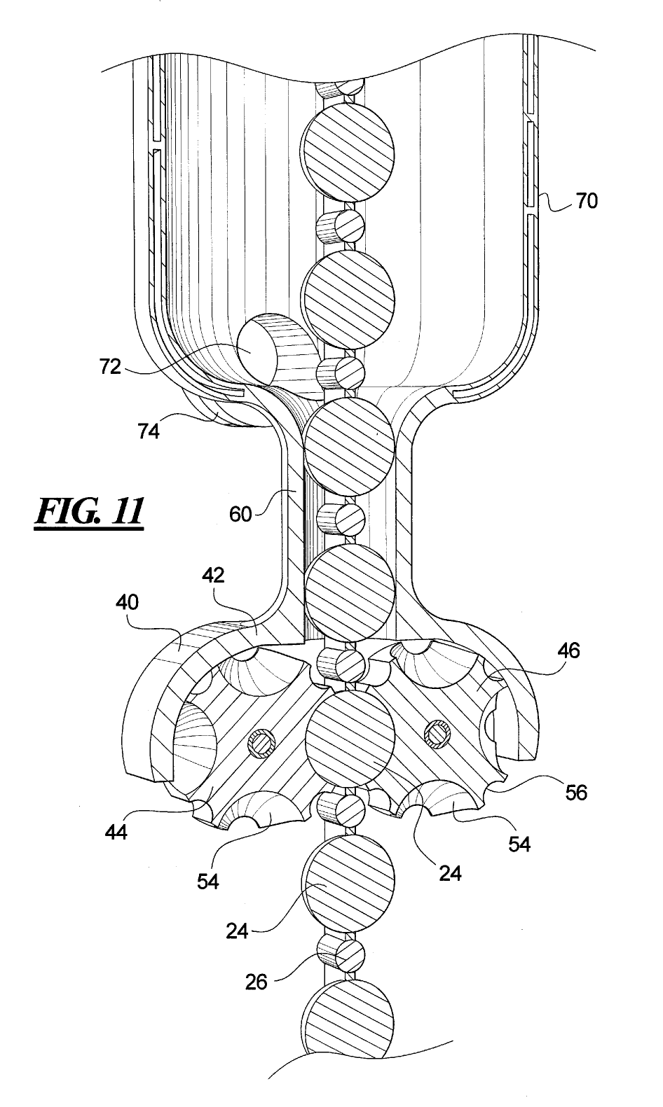

In FIG. 11, the elongated fuel structure 20 has been drawn further between the wheels 44 and 46 so that the shaped recess 54 in the wheels engages the propellant element 24. The engagement provides a seal preventing loss of the gases in the high pressure area 61. The gas generator ignites while in the high pressure area, or continues its gas generating activities while in this position, so that the high pressure is provided to push the propellant elements along the exit tube 60.

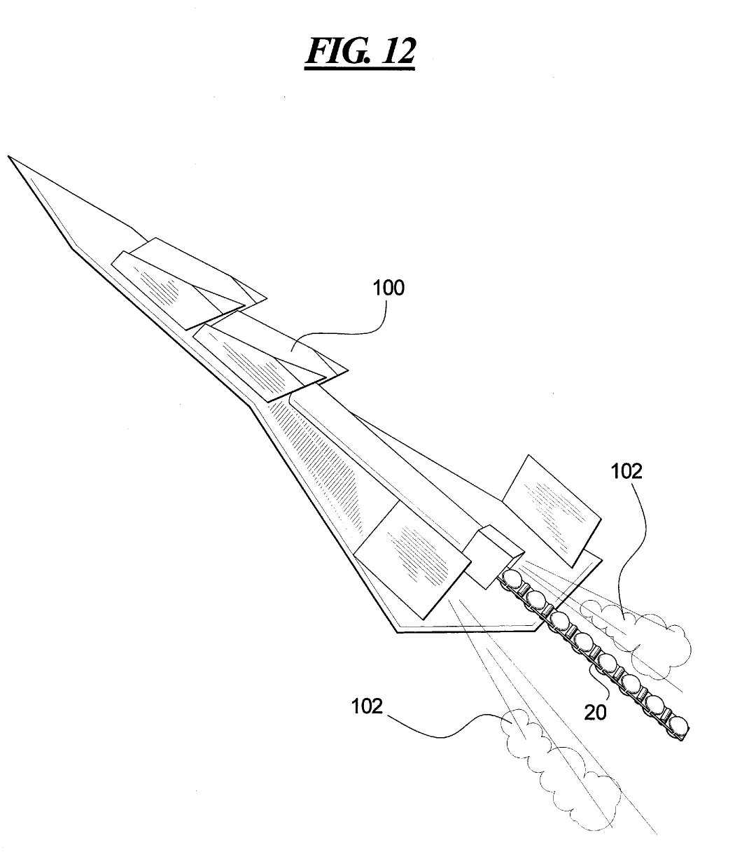

In FIG. 12, a craft, such as a passenger carrying craft or freight carrying craft is provided with the present rocket engine. Other uses include science and military and civilian applications. Two exhaust streams extend from nozzles of the rocket engine to provide thrust for atmospheric and super-atmospheric travel, while a strand of propellant elements, in the form of the elongated fuel structure 20 extends from the rear of the craft between the exhaust streams. In a preferred embodiment, the craft is a rocket plane for atmospheric travel so as to avoid ITAR restrictions on use. The preferred rocket plane operates at an altitude of approximately 75 km and achieves extreme hypersonic speeds. Preferred travel is at an approximate one half orbital distance between take off and destination. Take off can be from a runway or by vertical take off. Landing at the destination is at an aircraft runway.

The present rocket engine may be combined with other types of engines, such as jet engines or other types of engines, to provide controlled landing, for example.

The methods and the apparatus described herein allow for substantial improvements in the mass fraction of solid rocket engines, decouples the propulsion system design from the rest of the vehicle, while increasing safety and not greatly increasing the complexity of the rocket engine. The propellant can be stored indefinitely, and relatively inexpensive operations are possible.

Various different embodiments are possible within the principles of the present invention. The principles of the present invention provide a pump to take solid propellant, gas generators, and coolants from low pressure outside the engine to the high pressure inside the engine. The propellant is used as the pistons/turbine blades of the pump—virtually eliminating the normal problems of pump parts wearing out because the parts are by definition consumable. Furthermore, solid propellants do not require tanks to maintain shape at low pressures, so tank mass is completely eliminated. In addition, solids can be shaped to provide aerodynamic lift while outside the engine, increasing the percentage of thrust that can be used effectively. For example, the elongated fuel structure may be formed into an aerodynamic shape or enclosed within an aerodynamic housing or sheath.

Safety is also increased. First, because of the dramatic mass savings, high safety factors may be used in the engine designs. Instead of the normal 1.5 factor of safety, a factor of 3 is quite reasonable. Further, because the propellant is kept external to the engine at ambient pressure it is not a fire or explosion hazard. In addition, if the engine stalls the propellant, the elongated fuel structure, is immediately ejected from the rocket, either by residual pressure in the engine chamber or by drag forces on the propellant still external to the craft—there is nothing holding the fuel inside the engine other than the injector pressure of the high pressure area. Finally, in the extreme event that something unexpected does happen to the propellant, most of the propellant is hundreds of meters away from the aircraft, rather than closely coupled to the craft.

In the present rocket engine, extremely large mass fractions are possible. Using a safety factor of 3 times the yield strength in stainless steel, a design mass fraction of 50 was achieved—the rocket engine could carry 50 times its mass in propellant. Assuming an average Isp of 250 seconds, this would allow a maximum velocity change of 9580 m/s—allowing flight to any point on the globe, without staging.

In addition, the heat shield and aerodynamic qualities of the aircraft are decoupled from the propulsion system. When the propellant is used up or is ejected by stopping the engine, it needs no heat shield as no tank remains behind. The wings do not need to provide enough lift to lift the propellant load, because it can have a useful lift to drag ratio. Control surface authority is not impacted by the propellant loads because the propellant is never present during unpowered flight. During powered flight the propellant hangs from the engine and so does not affect aerodynamic controls.

An additional advantage of the engine is that if used for vertical takeoff, the engine does not need to lift most of the propellant until after ascending several hundred meters. This allows takeoff thrust-to-weight ratios to be lower than normal, and allows smaller engines to be used for larger than previously allowable payloads. For example: a vertical takeoff aircraft that has a thrust just equal to its gross lift off mass would not normally leave the ground—but if the propellant is in a ribbon, over half the mass is still on the ground as the aircraft passes 100 meters altitude, allowing the aircraft to accelerate before the propellant completely leaves the ground even though the thrust to weight ratio would not normally allow takeoff.

The present invention moves the propellant, coolant, and gas generators behind the engine in a ribbon the can be several hundred meters long. In this construction, the propellant is a solid propellant, such as that used in the space shuttle solid rocket boosters. It consists of small balls embedded in the long ribbon. Other types of propellant and other configurations are possible.

The coolant and gas generators are also embedded in cylinders in the ribbon. The gas generator is in the center of the cylinder, so that when it is fired it forces the coolant out of the cylinder and into a holding area inside the high pressure side of the pumping mechanism.

The pump mechanism consists of two wheels that pass the ribbon between them, the wheels having cut outs for the propellant, coolant, and gas generator shapes. This is the entrance into the high pressure side of the pump, which is pressurized to a higher pressure than the combustion chamber. It serves to limit the flow of pressurant gases leaving the pump, and to provide support against the pressure inside the pump. Past the wheels there is a volume to allow the pressurant gases to provide a somewhat stable operating pressure. The ribbon passes through this volume, and the gas generators are operating as the ribbon passes through this space. The ribbon then goes through a tube, where the spherical solid fuel acts like a piston and is forced into the combustion chamber by the pressurant gas.

The gas generators are activated by an electric firing mechanism, such as a thin nichrome wire. To provide the electrical power required to fire the gas generators, a battery at the end of propellant ribbon sends current up through wires embedded in the ribbon. As the electrically conductive pump wheels roll over special sections of the wire, they close circuits and activate the gas generator at the correct time.

The coolant is forced out of its carrying cylinder by the pressurant gases, and flows into a containment area in the high pressure section of the pump. (This also helps to cool the gas generator's gases, making engine design easier). From there, it flows through small channels that wind throughout the engine, combustion chamber, and nozzles—similar to the cooling channels in other rocket engines. Once it has passed through all the cooling channels, the coolant is dumped into the combustion chamber, and eventually leaves the rocket through the nozzle providing some amount of thrust.

The ribbon, cylinders, and propellant all enter the combustion chamber through the tube at the exit of the pumping mechanism, and are all burned and eventually flow out of the nozzle, producing thrust.

Thrust can be modulated by either controlling the electric current provided to the gas generators by the battery (not firing some gas generators to lower the pump pressure), or by opening a valve to bypass the piston and allow pressurant gases to flow directly into the combustion chamber.

In order to provide responsive thrust vectoring, fast thrust modulation, and efficient high expansion ratio nozzles for the upper atmosphere, a special nozzle system is employed. First, there is a tube coming out of each side of the engine which is closed at the end opposite the engine. There are two small slots cut facing rearward near the end of each tube for the exhaust to flow out. The slots cover a larger area than required by the nozzle so that the nozzle can be turned for thrust vectoring. An array of nozzles are cut into a ring that is either inside the tube, or outside the tube, depending on the details of how the tube is created. The nozzles all face the same direction, so that slight changes in angle will vector the rockets thrust, providing a controlling mechanism. A second array of nozzles is cut into the opposite side of the nozzle rings, providing a higher expansion ratio. To use these high expansion ratio nozzles, the nozzle ring is rotated 180 degrees to place this second set of nozzles in line with the slot cut into the carrying tube. The second set can be used as the previous set was for thrust vectoring. If desired, other sets of nozzles may be added as well—though each additional nozzle set added reduces the maximum angle that thrust can be vectored.

By having four independent nozzle rings, thrust can be quickly modulated and vectored in any direction. If all rings are rotated the same direction, the rocket is rolled. If both rings on each side are rotated in the same direction, but an opposing direction is used for each side, the rocket is rotated in pitch. If the rings on one side are rotated in opposite directions, a yawing moment is added. If the rings on both sides are rotated in opposite directions, the thrust can be decreased.

The preferred embodiment provides a method of increasing the pressure of propellant or other fluid, preferably for a rocket engine, where the propellant is used as either a piston or turbine blade. The method may provide that the propellant (piston/turbine blade) has a gas generator embedded in it to create the drive gas for the pump. Further, the method may provide that the propellant (piston/turbine blade) has a coolant fluid embedded in it to cool the engine and/or pump.

In one embodiment, the propellant is a solid in the shape of a ball, embedded into a ribbon of strong material. The material of which the ribbon is formed may be nylon. As a further development, cylinders are interspersed between the balls to contain a gas generator and engine coolant. In further detail, the gas generator can be disposed in the middle of the coolant, so that when fired it forces the coolant out of the cylinder. Alternatively, the cylinder may be crushed to force the coolant out of the cylinder. The ribbon can be passed between two wheels, with cut-outs for any propellant/coolant/gas generator shapes—the two wheels providing a pressure seal as the ribbon enters the pumping cavity. In yet another aspect, the ribbon the leaves the pumping cavity through a tube, with the propellant acting as a piston. The propellant/ribbon may be configured to provide some aerodynamic lift to the craft. In case of engine failure, the propellant may be forcefully ejected from the engine. The propellant of a preferred embodiment is a solid. Alternatively, the propellant is a liquid inside a small sphere. The propellant may be a cryogenic solid. The invention may provide that the ribbon contains two conducting wires, allowing a battery at the end of the ribbon to activate the gas generators when each circuit is closed in turn by the sealing wheels.

According to one embodiment of the rocket engine, vectoring of the rocket thrust is accomplished using four or more rings with nozzle arrays cut into them. The nozzles can be turned small angles for thrust vectoring, or turned large angles to switch expansion ratios.

The elongated fuel structure or ribbon is external to the aircraft. The exhaust forms two streams to each side of the ribbon. The ribbon has some rigidity in the proper direction to prevent it from “whipping” into the nearby streams because of its flat shape, and because the exhaust streams leave the rocket at a small angle. Although in some embodiments the fuel structure may have a covering, that is not necessary in every embodiment and the covering adds extra mass to the aircraft that it would need to take all the way to its destination. In general, the preference is to throw as much stuff overboard as possible without endangering someone on the ground (as things thrown overboard should be vaporized first).

Another reason to not have an external structure around the ribbon is to simplify ground operations and takeoff. The aircraft should be able to use normal runways with either a “skid” for the ribbon to go over placed down the center of the runway, or a reel that reels out the ribbon as the vehicle takes off The reel is preferable, because it allows a higher takeoff acceleration, but that is probably a more difficult modification to the airport.

The exhaust from the thrust nozzle is kept from the fuel structure or ribbon portion at the back of the rocket by the ribbon being somewhat rigid in that plane (the flat plane of the ribbon keeps it from moving towards the exhaust). The exhaust leaves the rocket nozzle at a small angle away from the ribbon. This decreases the thrust somewhat but not by enough to cause serious issues, because the thrust is proportional to the cosine of the angle, while the exhaust clearance is proportional to the sine. For example, if the nozzle exhaust leaves the rocket nozzle 20 degrees away from the ribbon line, thrust is only decreased by 6%, while for every meter the exhaust travels it gets 0.34 meters away. (Proof: 0.96̂2+0.34̂2=1) In the atmosphere, this should be sufficient to keep the exhaust from interacting too much with the ribbon.

Once the atmospheric pressure starts to drop, though, the exhaust will eventually envelop the ribbon. Because of the lower pressure, however, the exhaust will have cooled (and in any case, a lower pressure gas cannot conduct much heat energy into a solid)—and the ribbon will have a thin ablative covering (for example, a few microns of nylon plastic or other material) that will keep it from burning. However, it is very hard to get this fuel to burn at one atmosphere, let alone less than one atmosphere—so that the fuel really needs to be inside the rocket's combustion chamber, for example at above 10 atmospheres or so, in order for it to burn.

The plastic coating is highly desirable for other reasons as well—it weatherproofs the propellant for more resilient storage and operations. It also makes ribbon production easier.

Also, at extreme altitude the injector gases (which are pretty cold after leaking out through the injector wheels) form a barrier between the ribbon and the exhaust plumes.

The ribbon extends hundreds of meters behind the rocket, which results in the ribbon experiencing drag. However, the present rocket provides a small frontal area, since the propellant is behind the rocket and not contained in a tank that is a structural part of the craft or attached to the craft. To a certain extent, to launch a payload into a near-orbital flight path requires a certain volume of propellant. In a standard rocket, height to width ratios are limited by structural integrity constraints. In large rockets (such as the Saturn V rocket), these constraints are relaxed and the designs are extremely tall: the Saturn V had minuscule air drag losses. As rockets scale down, even 10:1 gets hard to achieve because the propellant storage tanks buckle—they are extremely light-weight designs.

The elongated fuel structure or ribbon avoids this by turning the problem upside down—a stretched ribbon has no buckling forces, so it can be virtually any length. This permits the use of a smaller frontal area for a given volume with a long ribbon—and that decreases aerodynamic drag. The shape is not ideal, but not too bad, and can be tailored to a certain extant to minimize drag.

If the ribbon breaks, then the aircraft's acceleration would jump up, and the pilot would notice and throttle back immediately and after assessing the situation the pilot would probably abort to an alternate landing field. The ribbon breaking would no cause damage to the aircraft, but would obviously shorten the vehicle's maximum range.

The most dangerous situation for the pilot/vehicle would probably be the engine going out and the ribbon staying attached. It is unlikely that the vehicle would be landable in that state, so the recommended procedure would be to immediately pull a high-G maneuver which would force the ribbon from the engine, or cause the ribbon to snap. Either way, the aircraft would be much safer to land. Alternately, a ribbon severing or ribbon releasing mechanism may be provided to ensure that the elongated fuel structure is detached from the craft in the event of the engine being extinguished.

The ribbon and coolant cylinders are burned in the combustion chamber and any remains leaves though the nozzle. Or more exactly, the coolant cylinders ablate more than they burn—though nylon would at least provide some extra energy to the reaction. As the ribbon and attached coolant cylinders go into the combustion chamber, they remain attached as they quickly melt and then vaporize. Essentially, the non-propellant mass gets to the top of the combustion chamber before it loses all structural integrity, and by the time it gets back to the bottom the hot combustions gases from the propellant have vaporized it, or at least make the ribbon so flimsy that it will easily pass through the nozzle. Previous testing of hybrids has shown that very large sections of rubber can be thrown through a properly designed nozzle—sections much larger than the nozzle! The cylinders and ribbon material do not add much to thrust (in fact, it is predicted to decrease thrust by a tiny amount)—the important aspect is that their mass is removed, and removed in a way that does not endanger anyone on the ground.

Thrust is modulated by controlling the electrical current to the gas generator. The thrust change is done by controlling the amount of gas generated by the gas generator, and therefore the pressure in the injector. A higher pressure in the injector than in the chamber will accelerate the propellant into the chamber (more propellant provides more thrust), while a lower pressure will decelerate the rate at which the propellant is provided to the combustion chamber (less propellant results in less thrust). If no gas generators are firing the pressure in the injector will fall below the chamber pressure, because the injector gases leak out at the pump exit tube and at the back of the injector—the ribbon does not perfectly seal the injector. A higher degree of sealing at the pump wheels would require less injector gas to be required and so the present invention contemplates incorporating seal configurations and materials that provide improved sealing. A challenge for the seal is to accommodate hot or at least warm gases. Embodiments with less effective seals at the pump wheels provide leaked injector gas which forms a barrier between the exhaust plumes and the ribbon at high altitude.

A design detail—the easiest way to make the gas generators able to be modulated is to have multiple generators in a line in the same cylinder. For example, three gas generators are provided in a row (with the coolant only on the outer most sides) there is the possibility of only firing the outer two gas generators. This would generate less gas than firing all three, but would still push all the coolant out—and the remaining gas generator would be burnt inside the combustion chamber. This can be simply extended to any number of generators—though this may not be required for typical usage.

A further design detail—the gas generators are very simple, essentially just a low temperature burning solid (like gunpowder) in close proximity to a thin wire used to ignite it.

The injector volume is at higher pressure than the chamber, and so the propellant is pushed into the chamber by the pressure difference. The pressure in the combustion chamber during normal operation does not force the ribbon out the back of the injector instead forward into the chamber. This is because the wheels at the bottom of the injector area support the pressure load, and the propellant spheres do not “see” the injector pressure until they are inside the injector. Essentially, the injector functions in much the same way as a gear pump.

The present rocket engine is a continuous thrust engine as opposed to a pulsed engine. Engine mass is highly correlated to the amount of propellant it must contain, so propellant is to flow into the engine, burn, and flow out the nozzles as quickly as possible.

The coolant itself is pooled up and then travels throughout the engine (cooling it) and turns to steam and then is dumped into the chamber. (It can be dumped into the chamber because it is coming from the injector, which is at a higher pressure.)

If the engine where to shut off while some of the elongated fuel structure is still hanging from the engine, it would dramatically affect the aerodynamic control—the craft would quickly become virtually uncontrollable, and which is a serious situation that would require immediate action to correct. The ribbon will not stay attached to the engine unless it is running, as it is only held in against the force of the combustion chamber's pressure (or, if the engine has completely gone out, the ribbon's drag) by the injector pressure. In the case of an injector failure, the combustion chamber's pressure will eject the ribbon. In the case of an engine losing pressure (a flame-out of some kind), the injector pressure goes away in seconds (as no new gas generators are being fed into it once the combustion chamber is filled), and the aerodynamic drag on the ribbon pulls it out of the injector. In the case of catastrophic engine failure, the ribbon is not held to the aircraft in any way other than the engine injector—so the ribbon falls away from the aircraft.

As long as the engine is running, aerodynamic controls are not used for maneuvering—thrust vectoring is used instead, so the inherent aerodynamic instability doesn't matter. In fact, as long as there is thrust, the vehicle is aerodynamically stable. One conceptualization is that of a kite with a long tail. In the aircraft, RCS thrusters are also used to maneuver after main engine cut off—these could also be used to provide a force to pull the ribbon from the aircraft in an emergency.

The gas from the gas generator becomes the “atmosphere” inside the injector. Most of that gas will eventually flow through the tube into the combustion chamber, pushing the propellant along in front of it. From there, it mixes with the combustion gases and flows out through the nozzles. A small amount of the pressurant gas leaks around the wheels and flows out the back of the injector. Since this is a very small amount of gas compared to the combustion gases, the effect on performance is very small—but at high altitudes, when the exhaust plume completely envelops the vehicle, this small amount of leakage gas is nice to have around because it is a lot cooler than the main combustion flow.

The coolant is initially pushed from the cylinders “near/above” the coolant holding area by the gas generators. Essentially, the coolant will be sprayed out of the cylinders, and collect in a pool in the holding area as gravity/thrust forces pull it into the collection area. When the engine is started, above is determined by gravity. Once the engine is running, above is determined by thrust.

The coolant of a preferred embodiment is a liquid, which takes advantage of the energy absorption of the liquid-gas transition in the cooling system, and in one embodiment is water. It is unnecessary to take special precautions to separate the water from the gas generator gas, because gravity or thrust makes the coolant fall down into the collection area. Some coolant will most likely be vaporized by the initially hot gas generator gas, but this has little or no negative impact in engine performance, the vapor is considered part of the gas generator gas, which should be relatively cool anyway.

The combustion chamber, nozzle supports, pump exit tube and other portions of the device include an arrangement of coolant passages, which extend through much of the structure except the injector which is not very hot.

Thus, there is shown and described a rocket engine for manned or unmanned space flight and atmospheric flight uses an elongated fuel structure that is external to the combustion chamber and that is fed into the combustion chamber during operation of the rocket. The elongated fuel structure includes propellant elements and may include coolant elements and gas generating elements as well. The elongated fuel structure of one embodiment is a ribbon. The ribbon is fed between two opposed wheels of the fuel pump, which seal the engine from escaping gases while permitting the elongated fuel structure to be drawn into the engine. The opposed wheels may serve to activate the gas generating elements, so that gas pressure generated thereby drives the propellant elements into the combustion chamber of the rocket engine. The activation of the gas generating elements also provides coolant to the engine from the coolant elements, in one embodiment.

Although other modifications and changes may be suggested by those skilled in the art, it is the intention of the inventors to embody within the patent warranted hereon all changes and modifications as reasonably and properly come within the scope of their contribution to the art.

We claim:

1. An apparatus as fuel for a rocket engine, comprising:
an elongated body; and
a plurality of solid fuel bodies disposed at spaced intervals along said elongated body so that said solid fuel bodies are fed sequentially into a combustion chamber of a rocket as said elongated body is fed into the combustion chamber.

2. An apparatus as claimed in claim 1, further comprising:
a plurality of coolant chambers disposed at spaced intervals along said elongated body.

3. An apparatus as claimed in claim 1, further comprising:
a plurality of gas generators disposed at spaced intervals along said elongated body.

4. A rocket engine, comprising;
a combustion chamber enclosing a combustion space for burning of propellant;
at least one nozzle in fluid communication with said combustion chamber through which rocket exhaust is directed to provide thrust;
a pump exit tube having first and second ends, said first end connected in fluid communication with said combustion chamber;
a pump connected to said second end of said pump exit tube, said pump including first and second pump wheels mounted for rotation in said pump and disposed for rotation along parallel axes, said pump defining a high pressure area within said pump;
an elongated fuel structure extending to between said first and second pump wheels, into said high pressure area of said pump, through said pump exit tube, and into said combustion chamber, said elongated fuel structure including propellant for combustion in said combustion chamber.

5. A rocket engine as claimed in claim 4, further comprising:
a plurality of gas generating elements disposed along said elongated fuel structure and operable to discharge a gas in said high pressure area of said pump.

6. A method for providing fuel to a rocket engine, comprising the steps of:
feeding a portion of an elongated fuel structure into a pump from outside the rocket engine;
generating gas by a gas generator in the portion of the elongated fuel structure in the pump to provide a high pressure area within the pump;
urging propellant elements in the portion of the elongated fuel structure along a pump exit passage by pressure in the high pressure area;
receiving propellant elements into a combustion chamber from the pump exit passage;
burning the propellant elements in the combustion chamber; and
expelling exhaust from the burned propellant elements from nozzles in fluid communication with the combustion chamber.

7. A method as claimed in claim 6, wherein said step of feeding includes feeding a portion of the elongated fuel structure between two wheels in the pump.

8. A method as claimed in claim 6, wherein said rocket engine is mounted in a craft, and said elongated fuel structure extends behind the craft during operation of the rocket engine.
